(19) United States
(12) Patent Application Publication
(10) Pub. No.: US 2006/0221476 A1
(43) Pub. Date: Oct. 5, 2006

(54) Magnetic disk apparatus, method for reproducing magnetic recording, and method for read retry

(75) Inventor: Hiroaki Ueno, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/191,186

(22) Filed: Jul. 27, 2005

(30) Foreign Application Priority Data
Mar. 30, 2005 (JP) 2005-096615

(51) Int. Cl. G11B 5/02; G11B 21/02

(52) U.S. Cl. 360/25; 360/75

(57) ABSTRACT

In the case that perpendicular magnetic recording is used, when a cut-off frequency fc of a high-pass filter of a head output is small, an error rate can be improved more when a PR target having a DC component is used and, when the cut-off frequency fc is large, an error rate can be improved more when a PR target not having a DC component is used. With this fact as a logical ground, in the present invention, when TA does not occur, PR equalization is performed using the PR target having a DC component and, when TA occurs, the cut-off frequency fc is increased to cut a low frequency component of a head reproduction signal and, additionally, PR equalization is performed using the PR target not having a DC component.

### CROSS-REFERENCE TO RELATED APPLICATIONS

This application claims the conventional priority based on Japanese Patent Application Serial No. 2005-096615, filed on Mar. 30, 2005, the disclosures of which are incorporated herein by reference.

### BACKGROUND OF THE INVENTION

1. Field of the Invention

This invention generally relates to a magnetic disk apparatus, a method for reproducing magnetic recording that is executed in the magnetic disk apparatus, and a method for read retry that is executed in the magnetic disk apparatus.

To describe more specifically, the present invention relates to a magnetic recording reproduction technique that makes it possible to restrain deterioration in an error rate when thermal asperity (TA) occurs in a reproduction process of perpendicular magnetic recording, and relates to a read retry technique that makes it possible to realize read with a small number of times of retry when read retry due to thermal asperity is performed.

2. Description of the Related Art

A perpendicular magnetic recording system has been studied earnestly which magnetize a magnetic film of a magnetic recording medium in a vertical direction because it is possible to realize improvement in a recording density.

On the other hand, in order to cope with a problem of an insufficient SN ratio that occurs when it is attempted to improve a recording density, an MR head has been widely used which is adopted a magneto-resistive effect, in which a resistance changes when a magnetic field is applied to a head.

TA will be described schematically. Note that a behavior of a head reproduction signal at the time when TA occurs is studied in detail in “H. Mutoh, “Study of thermal asperity suppression,” The 4th MDFE consortium meeting, Singapore, Apr. 24, 1998”.

TA is a phenomenon that occurs when a protrusion on a magnetic recording medium comes into contact with an MR head for reproduction. TA shows a characteristic that a resistance of the MR head increases significantly because of-a frictional heat caused by the contact. Occurrence of TA is detected at a point when a preamplifier output of a head reproduction signal exceeds a TA slice.

Since a capacitor is set in a preamplifier at a first stage of a reproduction circuit, attenuation of the head reproduction signal after the occurrence of TA depends on a time constant defined by the capacitor and a resistor, that is, a cut-off frequency fc of a high-pass filter formed by the capacitor and the resistor. In a normal state that no TA occurs, it is necessary to cause the head reproduction signal to pass as directly as possible. Thus, the time constant should be set large. In other words, usually, it is necessary to cause the head reproduction signal to pass as directly as possible. Thus, the cut-off frequency fc of the high-pass filter of a head output is set as small as possible to prevent a low frequency component of the head reproduction signal from being cut.

When TA occurs, the head reproduction signal changes greatly because the resistance of the MR head changes greatly. As a result, when the time constant is set large, an influence of the TA lasts for a long time. Due to this influence, the cut-off frequency fc of the high-pass filter of the head output is increased to cut a low frequency component of a head reproduction signal, so that a term of the head reproduction signal to be affected by the TA is reduced.

As described above, when TA occurs, if a large time constant is kept as in an ordinary state that TA does not occur, an influence of the TA lasts for a long time as shown in FIG. 12A. Thus, in the conventional technique, taking this fact into account, the cut-off frequency fc of the high-pass filter of the head output is increased to cut a low frequency component of a head reproduction signal, so that a term of the head reproduction signal to be affected by the TA is reduced, as shown in FIG. 12B.

On the other hand, as a technique for removing waveform distortion of a head reproduction signal, a Partial Response (PR) method is widely used.

In this PR method, for example, when a partial response target (PR target) having a characteristic [4, 3, −2, −3, −2] is used, the following arithmetic operation for the PR target is applied to a head reproduction signal to remove waveform distortion of the head reproduction signal
[4, 3, −2, −3, −2]≡[4+3D−2D²−3D³−2D^{4]}
where D is a delay operator.

An ability for removing waveform distortion of a head reproduction signal (a level of an error rate) depends on what kind of PR target is used.

In the case of a longitudinal magnetic recording system that has been generally used, a PR target having a differential component for setting a sum of values described in “[ . . . ]” to zero has been used as the PR target. However, in the case of a perpendicular magnetic recording system, it is reported that an error rate can be improved more when a PR target having a DC component for not setting a sum of values described in “[ . . . ]” to zero is used (see, for example, M. Madden, M. Oberg, Z. Wu, and R. He, “Read Channel for Perpendicular Magnetic Recording,” IEEE TRANSACTIONS ON MAGNETICS, VOL. 40, NO. 1, pp. 241-246, 2004).

In using this PR target, in the conventional technique, regardless of whether the longitudinal or the perpendicular magnetic recording system is used, it is determined at a shipment stage what kind of PR target is used. Thus, the PR target is once determined, the determined PR target is permanently used after that. The PR target is never changed dynamically when magnetic recording data is read.

In the conventional technique, as shown in a flowchart of FIG. 13, when occurrence of TA is detected because a preamplifier output of a head reproduction signal exceeds a TA slice, processing for simply increasing the cut-off frequency fc of the high-pass filer of the head output to cut a low frequency component of the head reproduction signal is performed. The PR target is never changed dynamically.

M. Madden et al. mentions that, when the perpendicular magnetic recording system is used, it is possible to improve an error rate by using the PR target having a DC component. However, M. Madden et al. does not mention at all that, when TA occurs, the PR target is changed dynamically.

In M. Madden et al., it is reported that, when the perpendicular magnetic recording system is used, it is possible to improve an error rate by using the PR target having a DC component.

However, this is a study that is performed on the premise that no TA occurs in an ordinary state. In other words, the study is performed on the premise that the cut-off frequency fc of the high-pass filter of the head output is sufficiently small.

However, actually, when TA occurs, the cut-off frequency fc of the high-pass filter of the head output is increased to cut a low frequency component of a head reproduction signal, thereby a term of the head reproduction signal affected by the TA is reduced.

Therefore, in a state that the cut-off frequency fc of the high-pass filter of the head output is increased to cut a low frequency component of a head reproduction signal, it is not guaranteed that an error rate can be improved by using the PR target having a DC component.

As described later, a result of a simulation performed by the me indicates that, in a state that the cut-off frequency fc of the high-pass filter of the head output is increased to cut a low frequency component of a head reproduction signal, an error rate can be improved more when the PR target having a differential component is used than when the PR target having a DC component is used.

As it is evident from this result of the simulation, in the conventional technique, since a PR target is not dynamically changed when magnetic recording data is read, there is a problem in that an error rate is deteriorated when TA occurs.

Additionally, in the conventional technique, since a PR target is not changed dynamically, even when data of a certain sector cannot be read and read retry for attempting to read the data of the sector by changing reading conditions in various ways is executed, a PR target is not changed for the read retry.

Therefore, according to the conventional technique, there is a problem in that read cannot be realized with a small number of times of retry, when read retry due to TA is performed.

### SUMMARY OF THE INVENTION

The present invention has been made in view of such circumstances, and it is an object of the present invention to provide a new magnetic recording reproduction technique that makes it possible to restrain, when TA occurs, deterioration in an error rate and a new read retry technique that makes it possible to realize, when read retry due to TA is performed, read with a small number of times of retry.

[1] Structure of the present invention for realizing restraint of deterioration in an error rate when TA occurs

In order to make it possible to restrain deterioration in an error rate when TA occurs, a plurality of partial response targets are provided and used, or a magnetic disk apparatus of the present invention includes, when perpendicular magnetic recording is used, a detecting unit that detects whether TA has occurred or not, and a changing unit that changes, when TA occurs, characteristics of a PR target to characteristics different from those used when TA does not occur.

Specifically, the detecting unit and the changing unit are included in an LSI (or semiconductor integrated circuit device) for reproducing magnetic recording mounted on the magnetic disk apparatus.

When such a structure is adopted, a programmable PR target (a PR target for which a characteristic of PR equalization can be changed by rewriting parameters) may be used or a selectable PR target (a PR target for which a characteristic of PR equalization can be changed by selecting one parameter out of a plurality of parameters) may be used as a PR target that is used when TA occurs.

As described later, a result of a simulation performed by me assuming that perpendicular magnetic recording is used indicates as follow: In a state that the cut-off frequency fc of the high-pass filter of the head output is small, as reported in M. Madden et al., an error rate can be improved more when a PR target having a DC component is used than when a PR target having a differential component is used. On the other hand, a result of the simulation further indicates as follow: In a state that the cut-off frequency fc of the high-pass filter of the head output is large, an error rate can be improved more when the PR target having a differential component is used than when the PR target having a DC component is used.

According to the results of the simulation obtained by the me, the magnetic disk apparatus of the present invention described above has such structure as shown in FIG. 1 in a form of a flowchart to realize the restraint of deterioration in an error rate when TA occurs. That is, this restraint is realized by performing, when the magnetic disk apparatus detects occurrence of TA, processing for increasing the cut-off frequency fc of the high-pass filter of the head output to cut a low frequency component of a head reproduction signal and, additionally, by changing characteristics of a PR target from the PR target having a DC component to the PR target not having a DC component.

For example, characteristic of a PR target are changed from the PR target having a DC component to a PR target not having a DC component [4, 3, −2, −3, −2], a PR target not having a DC component [2, 4, −2, −3, −1], or a PR target not having a DC component [3, 3, −2, −3, −1].

In this way, in the present invention, in the case that perpendicular magnetic recording is used, when TA occurs, a low frequency component of a head reproduction signal is cut by increasing the cut-off frequency fc of the high-pass filter of the head output and, additionally, a PR target is changed to another PR target with which an error rate can be improved. Therefore, it is possible to restrain deterioration in an error rate when TA occurs.

[2] Structure of the present invention for realizing read with a small number of times of retry

When read retry due to TA is performed, in order to make it possible to realize read with a small number of times of retry, the magnetic disk apparatus of the present invention includes read retry executing unit that changes, when it is necessary to perform the read retry because of occurrence of TA in the case that longitudinal magnetic recording or perpendicular magnetic recording is used, characteristics of a PR target to execute the read retry.

The magnetic disk apparatus of the present invention comprised as described above changes, when it is necessary to perform read retry because of occurrence of TA, characteristics of a PR target to execute the read retry.

In this way, in the present invention, when it is necessary to perform read retry because of occurrence of TA, the read retry is executed while a PR target is changed, which is not performed in the conventional technique. Therefore, when read retry due to TA is performed, it is possible to realize read with the number of times of retry smaller than that in the conventional technique.

As described above, according to the present invention, when perpendicular magnetic recording is used, it is possible to restrain deterioration in an error rate when TA occurs.

Moreover, according to the present invention, when read retry due to TA is performed, it is possible to realize read with the number of times of retry smaller than that in the conventional technique.

### BRIEF DESCRIPTION OF THE DRAWINGS

FIG. 1 is a diagram showing processing of the present invention in a form of a flowchart.

FIG. 2 is a circuit diagram of an LSI for reproducing magnetic recording included in a magnetic disk apparatus to which the present invention is applied.

FIG. 3 is a diagram showing an example of a structure of a PR target for realizing the present invention.

FIG. 4 is a graph for describing a result of a simulation indicating effectiveness of the present invention.

FIG. 5 is a graph for describing a result of the simulation indicating effectiveness of the present invention.

FIG. 6 is a graph for describing a result of the simulation indicating effectiveness of the present invention.

FIG. 7 is a graph for describing a result of the simulation indicating effectiveness of the present invention.

FIG. 8 is a graph showing an example of characteristics of a PR target used in the present invention.

FIGS. 9A and 9B are diagrams for describing a structure of a PR target for realizing the present invention.

FIG. 10 is a diagram for describing a structure for realizing read retry according to the present invention.

FIG. 11 is a flowchart of read retry processing according to the present invention.

FIGS. 12A and 12B are graphs for describing a conventional technique.

FIG. 13 is a graph for describing the conventional technique.

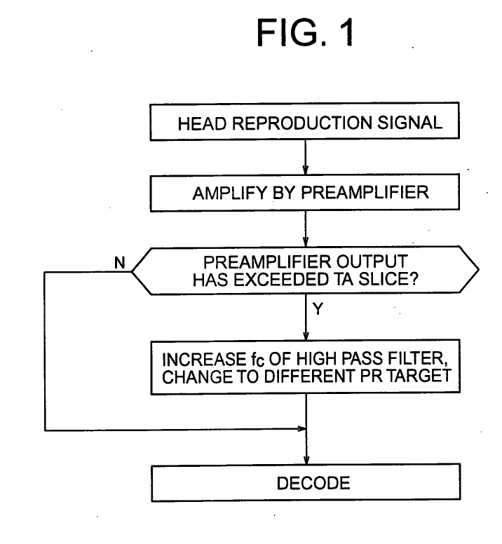

### DETAILED DESCRIPTION OF THE PREFERRED EMBODIMENTS

The present invention will be hereinafter described in detail according to an embodiment.

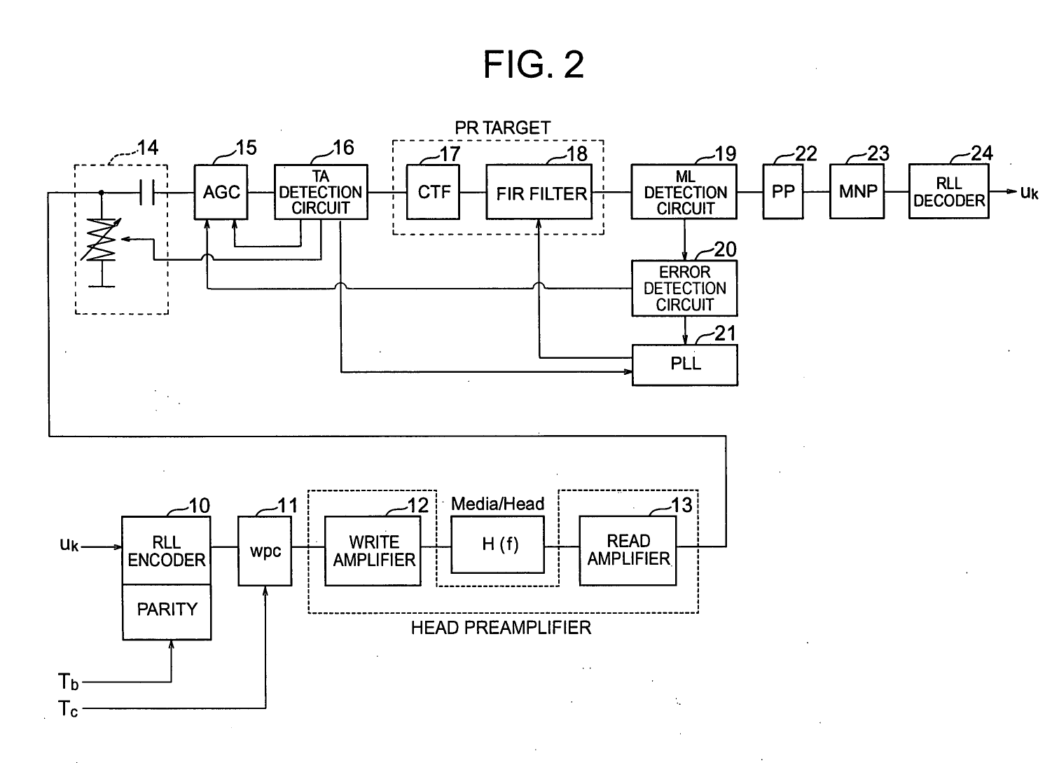

FIG. 2 shows a circuit structure of an LSI for reproducing magnetic recording which is included in a magnetic disk apparatus to which the present invention is applied. H(f) shown in FIG. 2 represents a function for an MR head and a magnetic recording medium adopting a perpendicular magnetic recording structure.

As shown in the FIG. 2, the LSI for reproducing magnetic recording, which is included in the magnetic disk apparatus to which the present invention, is applied, includes a Run Length Limited (RLL) encoder 10, a write pre compensation (wpc) circuit 11, a write amplifier 12, a read amplifier 13, a high-pass filter 14, an Automatic Gain Control (AGC) circuit 15, a TA detection circuit 16, a Continuous Time Filter (CTF) 17, a Finite Impulse Response (FIR) filter 18, a Maximum Likelihood (ML) detection circuit 19, an error detection circuit 20, a Phase Locked Loop (PLL) 21, a Post Processor (PP) 22, a Media Noise Processor (MNP) 23, and an RLL decoder 24.

The RLL encoder 10 has a parity adding function and converts written data uk into an RLL code. The wpc circuit 11 sets a pulse in a normal position with an output signal of the RLL encoder 10 as an input. The write amplifier 12 writes data in a magnetic recording medium with an output signal of the wpc circuit 11 as an input. The read amplifier 13 generates a head reproduction signal by reading the data written in the magnetic recording medium.

The high-pass filter 14 includes a resistor and a capacitor and cuts a low frequency component of an input signal with an output signal of the read amplifier 13 as an input. The ACG circuit 15 controls a level of the input signal to be constant with an output signal of the high-pass filter 14 as an input. The TA detection circuit 16 compares the input signal with a specified TA slice with an output signal of the AGC circuit 15 as an input to thereby detect occurrence of TA. The CTF 17 removes a noise of the input signal with an output signal of the TA detection circuit 16 as an input. The FIR filter 18 performs waveform equalization for the input signal with an output signal of the CTF 17 as an input.

The ML detection circuit 19 finds a data row closest to original data based on data rows in the past with an output signal of the FIR filter 18 as an input. The error detection circuit 20 detects an error extracted by the ML detection circuit 19. The PLL 21 performs control for adjusting a phase and a frequency based on the error detected by the error detection circuit 20. The PP 20 executes specified signal processing with an output signal of the ML detection circuit 19 as an input. The MNP 23 performs error correction with an output signal of the a post processor 22, as an input. The RLL decoder 24 decodes an RLL code with an output signal of the media noise processor 23 as an input to thereby restore the written data uₖ.

In this structure, a PR target comprises the CTF 17 and the FIR filter 18.

The resistor included in the high-pass filter 14 is comprised to switch a resistance value thereof according to a detection result of the TA detection circuit 16. According to this structure, when TA does not occur, the resistor sets a cut-off frequency fc of the high-pass filter 14 to be small to thereby operate not to cut a low frequency component of a head reproduction signal. On the other hand, when TA occurs, the resistor sets the cut-off frequency fc of the high-pass filter 14 to be large to thereby operate to cut a low frequency component of a head reproduction signal.

When occurrence of TA is detected by the TA detection circuit 16, the AGC circuit 15 and the PLL 21 operate to suspend the control performed by the AGC circuit 15 and the PLL 21, respectively.

As shown in the FIG. 2, a basic structure of the LSI for reproducing magnetic recording, which is included in the magnetic disk apparatus to which the present invention, is applied is the same as that in the conventional technique. However, the PR target is different from that in the conventional technique in order to realize the present invention.

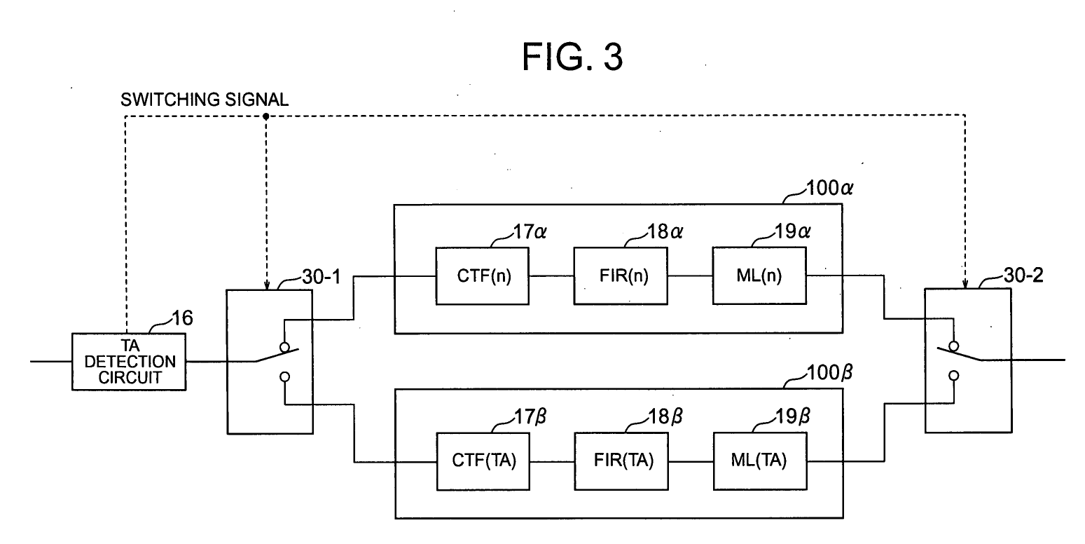

FIG. 3 shows an example of a structure of the PR target for realizing the present invention.

As shown in the FIG. 3, in the present invention, the PR target includes a PR target 100α, PR target 100β, and switches 30-1 and 30-2. The PR target 100α includes a CTF(n) 17α, an FIR(n) 18α, and an ML(n) 19α and operates when TA does not occur. The PR target 100β includes a CTF(TA) 17β, an FIR(TA) 18β, and an ML(TA) 19β and operates when TA occurs. The switches 30-1 and 30-2 selects the PR target 100α when the TA detection circuit 16 does not detect occurrence of TA and selects the PR target 100β when the TA detection circuit 16 detects occurrence of TA.

According to this structure, the LSI for reproducing magnetic recording, which is included in the magnetic disk apparatus to which the present invention is applied, performs processing to execute PR equalization using the PR target 100α when TA does not occur and execute PR equalization using the PR target 100β when TA occurs.

It is also possible that the CTF 17 and the ML 19 are shared by the PR target 100α and the PR target 100β and only the FIR 18 is switched between the FIR(n) 18α and the FIR(TA) 18β.

As the FIR(TA) 18β that is used when TA occurs, in order to make it possible to easily set an FIR filter matching a magnetic disk apparatus to be manufactured, it is preferable to use a programmable FIR filter for which characteristics of PR equalization can be changed by rewriting parameters or use a selectable FIR filter for which characteristics of PR equalization can be changed by selecting one parameter out of a plurality of parameters.

My simulation and the results, which form a logical ground for adopting such a PR target structure will be described.

This simulation was performed assuming that the function H(f) shown in FIG. 2, which represented a behavior of a signal when a step signal was given, was calculated as follows
H(f)=h tan[ln(3)×T/(Tb×Kp)]
where Tb corresponds to a sampling frequency and Kp is a parameter indicating sharpness at a rising edge of a reproduction signal.

This simulation was performed assuming that S(zero-peak)/rms Noise was used as S/N definition, assuming that there was no ρ-H curve, assuming that a reproduction signal was generated using linear convolution, assuming that fc=0.273×Tb and Boost=3 dB was used as circuit characteristics of the CTF 17, assuming that an LMS algorithm in 10 taps was used as circuit characteristics of the FIR filter 18, assuming that the MNP 23 had (+, +-+, +-+-+, +-, +0+, +-+-) as an error correction ability, and assuming that there was [AWGN, d Jitter, d Kp, DC EraseNoise] as noise and a magnitude of the noise was [0.25, 0.3, 0.2, 0.25].

Under these conditions, in this simulation, when six PR targets having characteristics [2, 3, 0, −1], [5, 6, 0, −1], [5, 4, −2,−1], [4, 3, −2, −3, −2], [2, 4, −2, −3, −1], and [3, 3, −2, −3, −1] were used, it was checked how error rates of the PR targets changed according to the cut-off frequency fc of the high-pass filter 14, respectively.

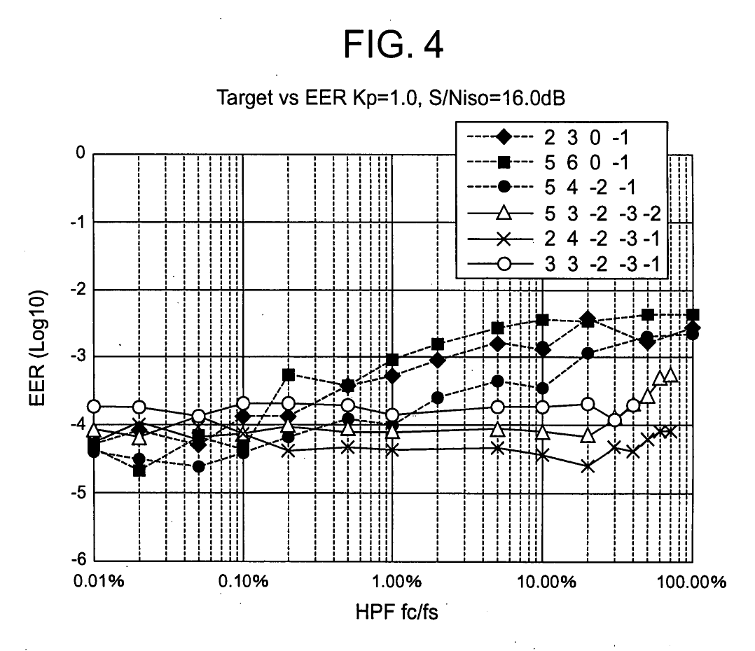

FIGS. 4 to 6 show the results of the simulation. In these results of the simulation, an abscissa indicates the cut-off frequency fc of the high-pass filter 14 that is normalized by a sampling frequency and an ordinate indicates an error rate represented by a value of log10.

In this simulation, a value of Kp normalized by the sampling frequency was changed in such a manner as “1.0”, “1.25”, and “1.5” and, then, an S/N ratio was adjusted such that an error rate at the cut-off frequency fc of 0.01% was about 10⁻⁴ when the PR target having a characteristic [4, 3, −2, −3, −2] was used.

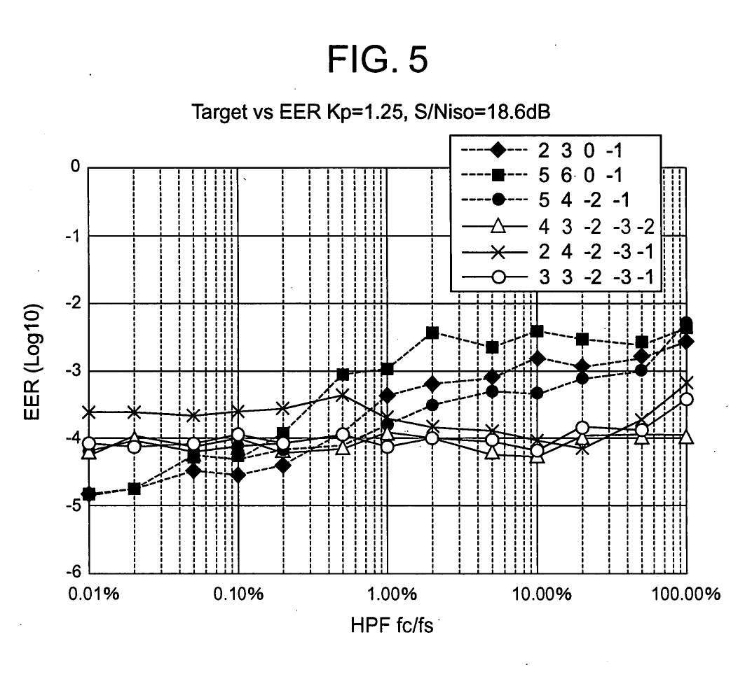

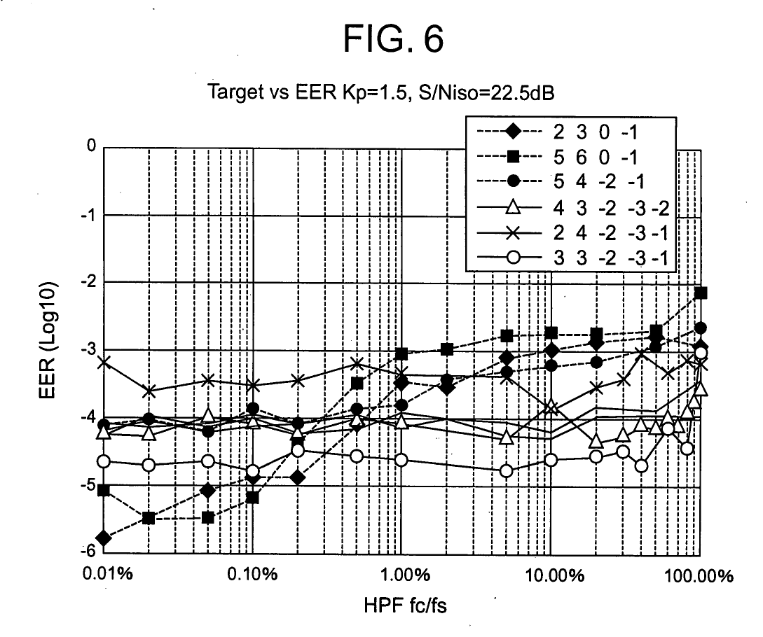

The result of the simulation in FIG. 4 indicates a result of the simulation at the time when “Kp is 1.0”. The result of the simulation in FIG. 5 indicates a result of the simulation at the time when “Kp is 1.25”. The result of the simulation in FIG. 6 indicates a result of the simulation at the time when “Kp is 1.5”.

From these results of the simulation, it is made clear that, in the case that the perpendicular magnetic recording is used,:

(1) when a PR target having a differential component for which a result of the simulation is represented by a solid line is used, an error rate does not change much and shows substantially a fixed value even if the cut-off frequency fc of the high-pass filter 14 increases,

(2) when a PR target having a DC component for which a result of the simulation is represented by a broken line is used, an error rate increases as the cut-off frequency fc of the high-pass filter 14 increases, and

(3) when the cut-off frequency fc of the high-pass filter 14 is small, an error rate can be improved more when the PR target having a DC component is used than when the PR target having a differential component represented by the solid line is used.

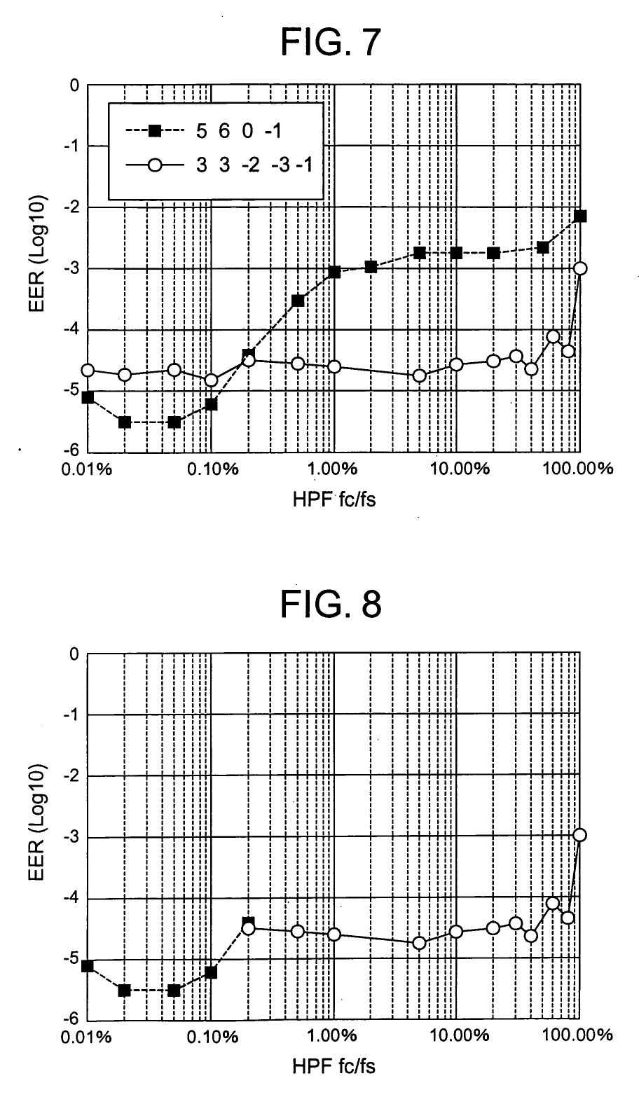

For example, as it is seen from FIG. 7 that shows only the results of the simulation of [5, 6, 0, −1] and [3, 3, −2, −3, −1] extracted from FIG. 6, it was made clear that:

(1) when the PR target having a differential component is used, an error rate does not change much even if the cut-off frequency fc of the high-pass filter 14 increases,

(2) when the PR target having a DC component is used, an error rate increases as the cut-off frequency fc of the high-pass filter 14 increases, and

(3) when the cut-off frequency fc of the high-pass filter 14 is small, an error rate can be improved more when the PR target having a DC component is used than when the PR target having a differential component is used.

In general, when TA occurs, the cut-off frequency fc of the high-pass filter 14 is increased to about 1% to 10%.

Therefore, in the present invention, the structure shown in FIG. 3 is used based on this point and the results of the simulation. Consequently, as shown in FIG. 8, deterioration in an error rate is restrained when TA occurs by using the PR target having a DC component [5, 6, 0, −1] when TA does not occur and by using the PR target having a differential component [3, 3, −2, −3, −1] when TA occurs.

An error rate is deteriorated by more of two digits by use of the PR target having a DC component, when TA occurs. However, it is possible to restrain the deterioration in the error rate to one digit according to this structure.

As it is seen from the results of the simulation shown in FIGS. 4 to 6, Kp determines what kind of PR target should be used as the PR target having a differential component that is used when TA occurs.

In short, when a value of Kp is small, as it is seen from the result of simulation in FIG. 4, it is preferable to use the PR target having a characteristic [2, 4, −2, −3, −1] because an error rate can be restrained. When a value of Kp is larger than that, as it is seen from the result of the simulation in FIG. 5, it is preferable to use the PR target having a characteristic [4, 3, −2, −3, −2] because an error rate can be restrained. When a value of the Kp is still larger, as it is seen from the result of the simulation in FIG. 6, it is preferable to use the PR target having a characteristic [3, 3, −2, −3, −1] because an error rate can be restrained.

In this way, in the present invention, in the case that the perpendicular magnetic recording is used, when TA occurs, the cut-off frequency fc of the high-pass filter 14 is increased to cut a low frequency component of a head reproduction signal and, additionally, a PR target is changed to be a different PR target with which an error rate can be improved.

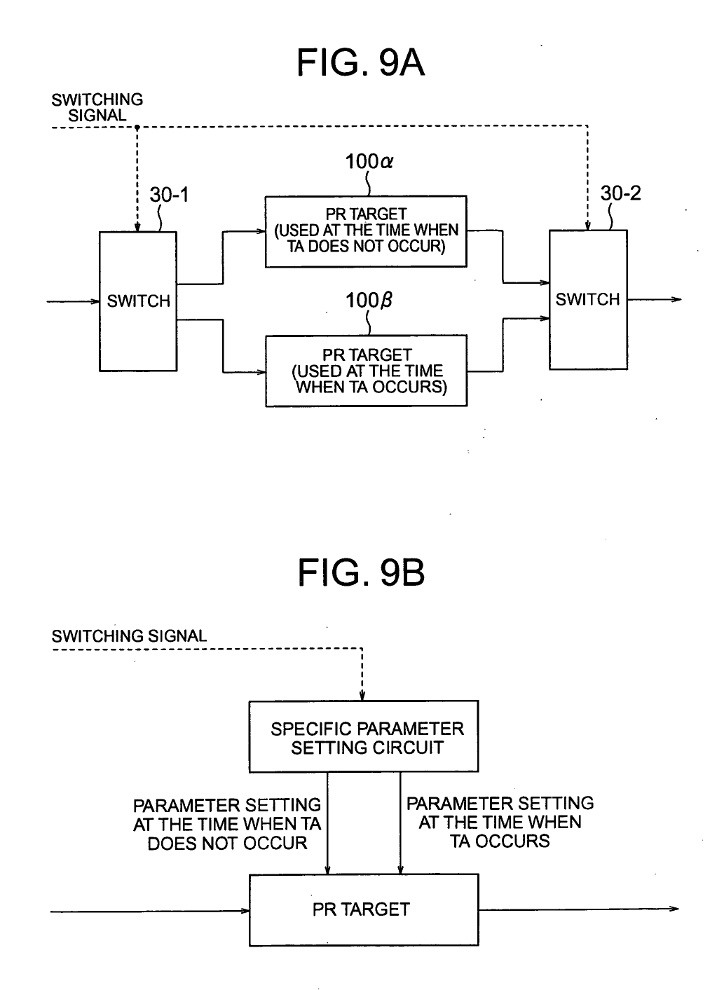

In realizing the improvement of an error rate, in the example of the structure shown in FIG. 3, as shown in FIG. 9A, the two PR targets, namely, the PR target 100α that operates when TA does not occur and the PR target 100β that operates when TA occurs are prepared and the PR targets are switched to restrain deterioration in an error rate. However, as shown in FIG. 9B, it is also possible to provide one PR target and, when TA occurs, set parameters different from parameters, which are set when TA does not occur, in the PR target to thereby realize the restraint of an error rate.

In other words, it is also possible to prepare one PR target, and set parameters for causing the PR target to operate as the PR target having a DC component when TA does not occur and set parameters for causing the PR target to operate as the PR target having a differential component when TA occurs to thereby restrain deterioration in an error rate.

In the present invention, unlike the conventional technique, it is possible to change a characteristic of a PR target.

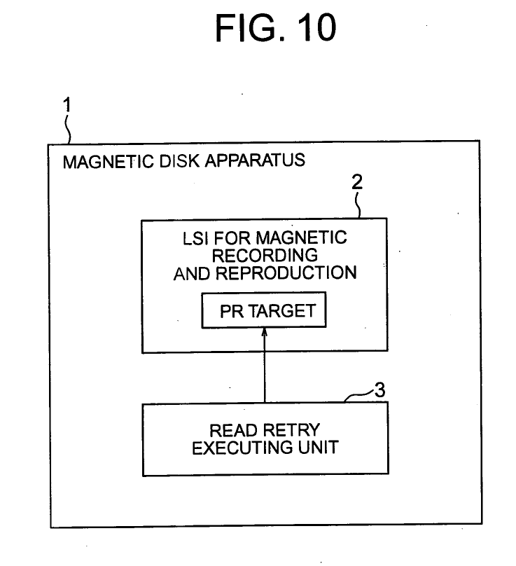

Therefore, as shown in FIG. 10, in a magnetic disk apparatus 1 of the present invention, when a read retry executing unit 3 cannot read data of a certain sector, the unit 3 executes read retry for changing reading conditions in various ways to try to read the data of the sector. In that case, the read retry is executed by making the PR target included in the LSI 2 for reproducing magnetic recording, which adopts the structure shown in FIG. 2, as an object of change of reading conditions. This makes it possible to realize read with the number of times of retry smaller than that in the conventional technique.

This structure is also applicable not only when the perpendicular magnetic recording is used but also when the longitudinal magnetic recording is used.

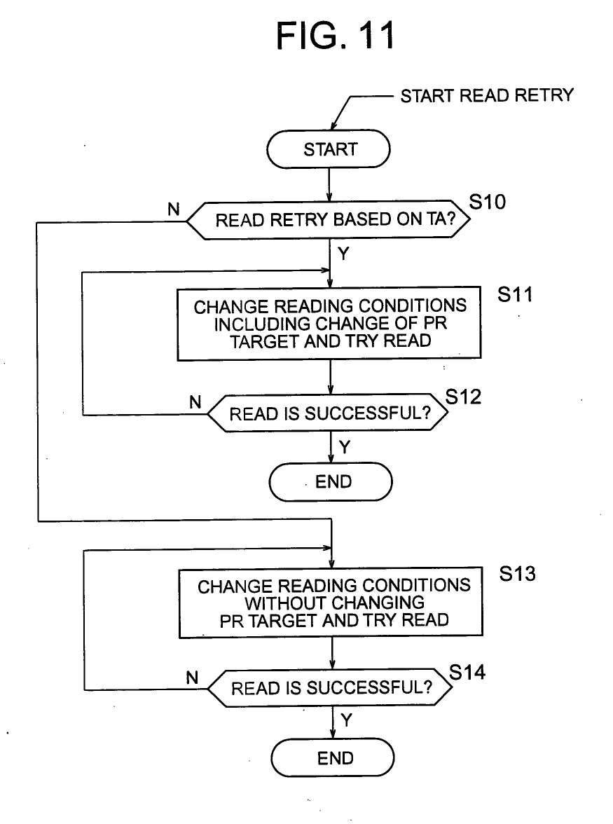

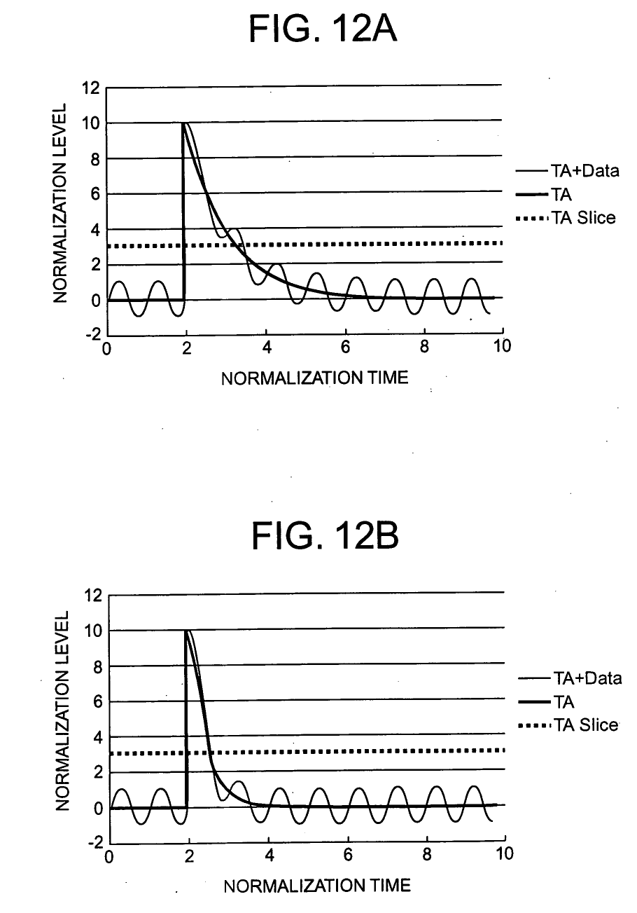

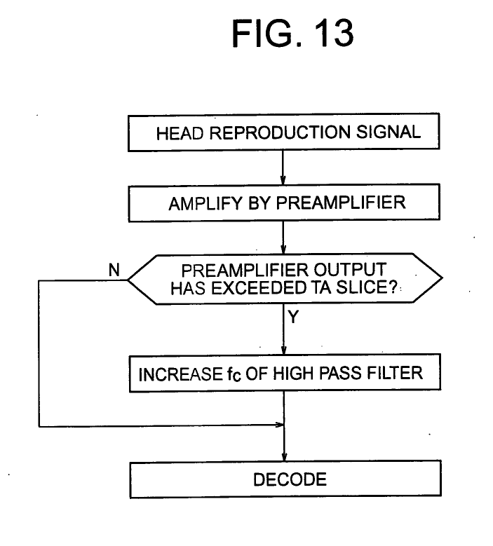

FIG. 11 shows an example of a flowchart of read retry processing that is executed by the read retry executing unit 3.

Read retry processing, which is executed by the present invention, will be described with reference to the flowchart.

The read retry executing unit 3 starts execution of read retry because it is impossible to read data of a certain sector. As shown in the flowchart of FIG. 11, first, in step S10, the read retry executing unit 3 judges whether the read retry to be executed is read retry based on TA.

According to this judgment processing, when it is judged that the read retry to be executed is read retry based on TA, the read retry executing unit proceeds to step S11 and changes reading conditions and also changes the PR target included in the LSI 2 for reproducing magnetic recording to try read. In the subsequent step S12, the read retry executing unit 3 judges whether read has been successfully performed by this try. When it is judged that read has not been successfully performed, the read retry executing unit 3 returns to step S11. By repeating this processing, the read retry executing unit 3 realizes read of the data of the sector that is an object of the read retry.

On the other hand, according to the judgment processing in step S10, when it is judged that the read retry to be executed is not read retry based on TA, the read retry executing unit 3 proceeds to step S13 and changes reading conditions without changing the PR target included in the LSI 2 for reproducing magnetic recording to try read. In the subsequent step S14, the read retry executing unit 3 judges whether read has been successfully performed by this try. When it is judged that read has not been successfully performed, the read retry executing unit 3 returns to step S13. By repeating this processing, the read retry executing unit 3 realizes read of the data of the sector that is an object of the read retry.

In this way, in the present invention, when it is necessary to perform read retry because of occurrence of TA, read retry is executed while a PR target is changed, which is not performed in the conventional technique.

In the present invention, in the case that the perpendicular magnetic recording is used, when TA occurs, the cut-off frequency fc of the high-pass filter of the head output is increased to cut a low frequency component of a head reproduction signal and, additionally, a PR target is changed to another PR target with which an error rate can be improved. Therefore, it is possible to restrain deterioration in an error rate when TA occurs.

In the present invention, when it is necessary to perform read retry because of occurrence of TA, read retry is executed while a PR target is changed, which is not performed in the conventional technique. Therefore, when read retry due to TA is performed, it is possible to realize read with the number of times of retry smaller than that in the conventional technique.

What is claimed is:

1. A method for reproducing magnetic recording executed in a magnetic disk apparatus, the method comprising:
using a plurality of partial response targets.

2. A method for reproducing magnetic recording executed in a magnetic disk apparatus for perpendicular magnetic recording, the method comprising:
detecting whether thermal asperity occurs; and
changing, in a case that the thermal asperity occurs, a characteristic of a partial response target to a characteristic different from that used in a case that the thermal asperity does not occur.

3. The method according to claim 2, wherein, in a case that the thermal asperity occurs, a partial response target having a DC component is changed to a partial response target not having a DC component.

4. The method according to claim 2, wherein a programmable partial response target is used as the partial response target used in a case that the thermal asperity occurs.

5. The method according to claim 2, wherein a selectable partial response target is used as the partial response target used in a case that the thermal asperity occurs.

6. The method according to claim 2, wherein a partial response target having a characteristic [4, 3, −2, −3, −2] is used as the partial response target used in a case that the thermal asperity occurs.

7. The method according to claim 2, wherein a partial response target having a characteristic [2, 4, −2, −3, −1] is used as the partial response target used in a case that the thermal asperity occurs.

8. The method according to claim 2, wherein a partial response target having a characteristic [3, 3, −2, −3, −1] is used as the partial response target used in a case that the thermal asperity occurs.

9. A semiconductor integrated circuit device for reproducing magnetic recording and mounted on a magnetic disk apparatus, the semiconductor integrated circuit device comprising:
a plurality of partial response targets.

10. A semiconductor integrated circuit device for reproducing magnetic recording and mounted on a magnetic disk apparatus for perpendicular magnetic recording, the semiconductor integrated circuit device comprising:
a detecting unit for detecting whether thermal asperity occurs; and
a changing unit for changing a characteristic of a partial response target to a characteristic different from that used in a case that the thermal asperity does not occur.

11. The semiconductor integrated circuit device according to claim 10, wherein the changing unit changes, in a case that the thermal asperity occurs, a partial response target having a DC component to a partial response target not having a DC component.

12. The semiconductor integrated circuit device according to claim 10, wherein a programmable partial response target is used as the partial response target used in a case that the thermal asperity occurs.

13. The semiconductor integrated circuit device according to claim 10, wherein a selectable partial response target is used as the partial response target used in a case that the thermal asperity occurs.

14. A method for read retry executed in a magnetic disk apparatus, the method comprising:
changing, in a case that it is necessary to perform read retry because of occurrence of thermal asperity, a characteristic of a partial response target to execute the read retry.

15. A magnetic disk apparatus comprising:
a read retry executing unit for changing, in a case that it is necessary to perform read retry because of occurrence of thermal asperity, a characteristic of a partial response target to execute the read retry.
